(19) United States
(12) Patent Application Publication
(10) Pub. No.: US 2017/0269821 A1
(43) Pub. Date: Sep. 21, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventors: Yusuke KANO, Yokohama-shi (JP); Kazunori HORIKIRI, Yokohama-shi (JP)

(73) Assignee: FUJI XEROX CO., LTD., Tokyo (JP)

(21) Appl. No.: 15/254,339

(22) Filed: Sep. 1, 2016

(30) Foreign Application Priority Data
Mar. 16, 2016 (JP) 2016-051799

(51) Int. Cl. G06F 3/0484

(52) U.S. Cl. CPC G06F 3/04845

(57) ABSTRACT

An information processing apparatus includes: a reception unit that receives a designation of an attachment position of a sticky note before attachment of the sticky note to a mount; and a warning unit that, when the sticky note is attached to the attachment position that is designated, presents a warning in a case where a comparison result between a state of other sticky note in a neighborhood of the attachment position at a time of the designation of the attachment position and a state of other sticky note in the neighborhood of the attachment position at a time of the attachment of the sticky note meets a predetermined condition.

### CROSS-REFERENCE TO RELATED APPLICATIONS

This application is based on and claims priority under 35 USC 119 from Japanese Patent Application No. 2016-051799 filed on Mar. 16, 2016.

### BACKGROUND

### Technical Field

The present invention relates to an information processing apparatus, an information processing method, and a non-transitory computer readable medium.

### SUMMARY

According to an aspect of the invention, there is provided an information processing apparatus including: a reception unit that receives a designation of an attachment position of a sticky note before attachment of the sticky note to a mount; and a warning unit that, when the sticky note is attached to the attachment position that is designated, presents a warning in a case where a comparison result between a state of other sticky note in a neighborhood of the attachment position at a time of the designation of the attachment position and a state of other sticky note in the neighborhood of the attachment position at a time of the attachment of the sticky note meets a predetermined condition.

### BRIEF DESCRIPTION OF DRAWINGS

Exemplary embodiments of the present invention will be described in detail based on the following figures, wherein:

FIG. 1 is a configuration diagram conceptually illustrating modules in a configuration example of an exemplary embodiment;

FIGS. 2A, 2B, and 2C are explanatory diagrams illustrating a configuration example of a system using the exemplary embodiment;

FIG. 3A is an explanatory diagram illustrating an example of a conference room, FIG. 3B is an explanatory diagram illustrating an example of use of a shared sticky note information processing apparatus, and FIG. 3C is an explanatory diagram illustrating an example of use of an electronic sticky note terminal using the exemplary embodiment;

FIG. 4 is a flowchart illustrating an example of a process performed by the exemplary embodiment;

FIG. 5 is an explanatory diagram illustrating an example of processing performed by the exemplary embodiment;

FIG. 6 is an explanatory diagram illustrating an example of a data structure of a sticky note information table;

FIG. 7 is an explanatory diagram illustrating another example of a data structure of a sticky note information table;

FIG. 8 is an explanatory diagram illustrating an example of a data structure of a mount information table;

FIG. 9 is an explanatory diagram illustrating an example of a data structure of a history table;

FIGS. 10A to 10F are explanatory diagrams illustrating another example of processing performed by the exemplary embodiment;

FIG. 11 is a flowchart illustrating another example of a process performed by the exemplary embodiment;

FIG. 12 is an explanatory diagram illustrating another example of processing performed by the exemplary embodiment;

FIG. 13 is an explanatory diagram illustrating another example of processing performed by the exemplary embodiment;

FIG. 14 is an explanatory diagram illustrating another example of processing performed by the exemplary embodiment; and

FIG. 15 is a block diagram illustrating an example of a hardware configuration of a computer that implements the exemplary embodiment.

### DETAILED DESCRIPTION

Hereinafter, examples of preferred exemplary embodiments in implementing the present invention will be described based on the drawings.

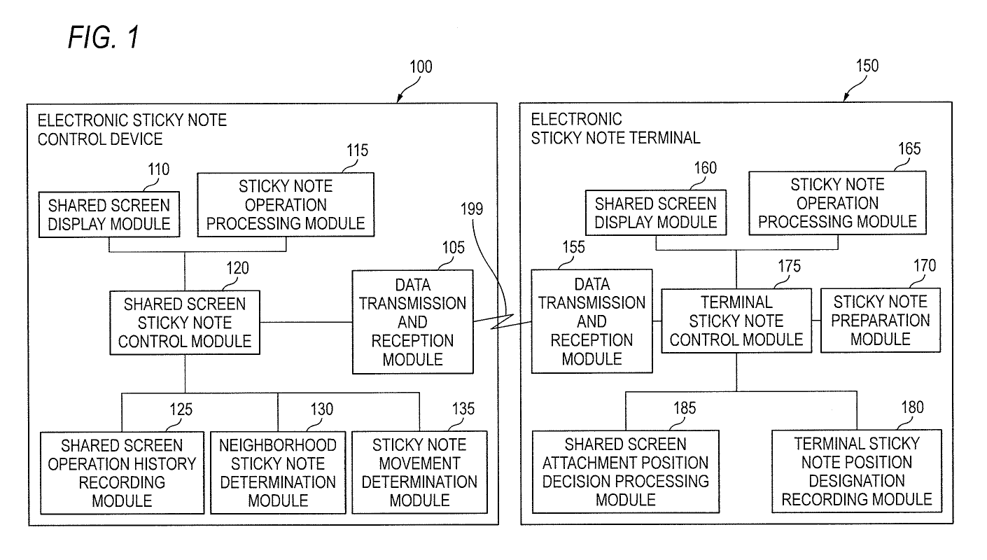

FIG. 1 is a configuration diagram conceptually illustrating modules in a configuration example of the exemplary embodiment.

A module generally refers to logically divisible pieces of software (a computer program) or hardware or the like. Accordingly, the module in the present exemplary embodiment refers not only to a module in a computer program but also to a module in a hardware configuration. Therefore, in the present exemplary embodiment, a computer program that functions as the modules (a program for causing a computer to execute respective procedures, a program for causing a computer to function as respective units, a program for causing a computer to implement respective functions), a system, and a method are also described. For the convenience of explanation, the expressions of “stores”, “is stored”, and other expressions equivalent to the expressions are used. However, in a case where an exemplary embodiment is a computer program, these expressions mean that something is caused to be stored in a storage device or control is performed such that something is stored in the storage device. The module may have a one-to-one correspondence with a function. However, in mounting the modules, a single module may include a single program, plural modules may include a single program, and in an opposite manner, a single module may include plural programs. Furthermore, plural modules may be executed by a single computer or a single module may be executed by plural computers in a distributed or parallel environment. Other modules may be included in a single module. In the following, the expression “connection” is also used in a case of a logical connection (sending and receiving of data, issuing of instructions, reference relationship between data, or the like) in addition to a physical connection. The expression “predetermined” is used to include the meaning that matters are determined before processing regarded as a target is performed, and matters are determined based on the situation and the state at that time or determined based on the situation and the state until that time before the processing regarded as the target is performed even after the processing in the present exemplary embodiment is started as well as before the processing in the present exemplary embodiment is started. In a case where there are plural “predetermined values”, the predetermined values may be respectively different values or two or more (also including all the values) of the predetermined values may be the same. The description signifying that “in a case of A, it is regarded as B” is used to signify that “it is determined whether it is A, and when it is determined that it is A, it is regarded as B”. However, a case where the determination as to whether it is A is unnecessary is excluded.

A system or an apparatus is configured in such a way that plural computers, hardware, apparatuses or the like are connected to each other via a communication unit such as a network (including communication connection on one-to-one correspondence), and may be implemented by a single computer, hardware, apparatus or the like. The “apparatus” and the “system” are interchangeably used herein as having the same meaning. The “system” does not include a social “mechanism” (a social system) that is merely an artificial arrangement.

A piece of information regarded as a target is read from the storage device for each processing by each module or for each processing in a case where plural processing is performed in the module and a processing result is written into the storage device after the processing is performed. Accordingly, description of the reading from the storage device before the processing and the writing into the storage device after the processing may be omitted. Here, the storage device may include a hard disk, a random access memory (RAM), an external storage medium, a storage device through a communication line, a register within a central processing unit (CPU) or the like.

An electronic sticky note control device 100 and an electronic sticky note terminal 150 which are exemplary embodiments perform processing concerning a sticky note used in a meeting.

As illustrated in the example of FIG. 1, the electronic sticky note control device 100 and the electronic sticky note terminal 150 are connected with each other through a communication line 199.

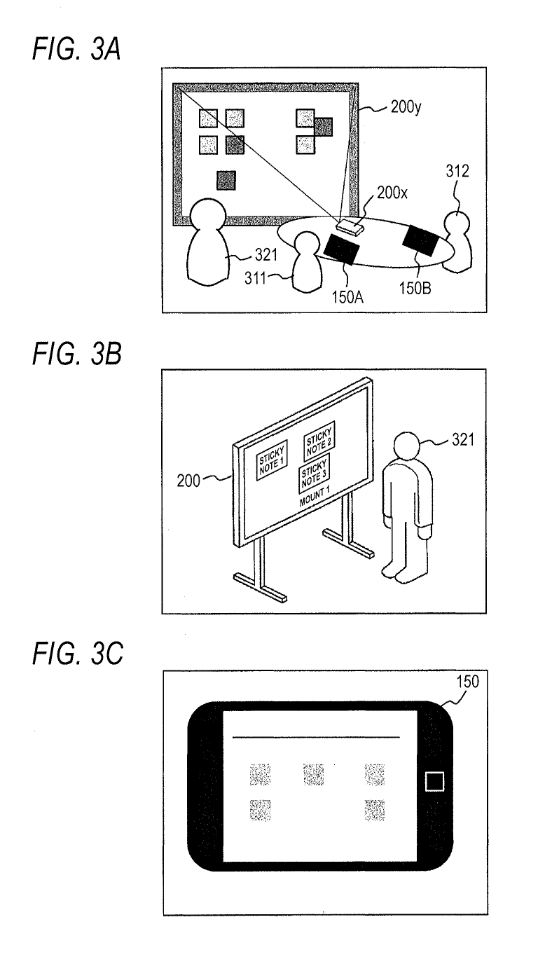

The electronic sticky note control device 100 is, specifically, used in a meeting (a workshop, a conference, an idea extraction meeting, an advisory meeting, or the like) performed by a facilitator (in general, a single person) and plural participants using the sticky notes. The participant prepares a sticky note in which an idea or the like is described using the electronic sticky note terminal 150 as a participant's terminal. In general, as the electronic sticky note terminal 150, as illustrated in the example of FIG. 3, plural electronic sticky note terminals 150A and electronic sticky note terminals 150B, and the like (hereinafter, representatively referred to as an electronic sticky note terminal 150), that are owned by respective participants, are present. The electronic sticky note control device 100 receives a sticky note from the electronic sticky note terminal 150 and attaches the sticky note on a mount (or background). A facilitator determines or alters a position of the sticky note or collects the sticky notes (associating a first sticky note with a second sticky note, which is referred to as grouping) on the mount, or prepares a piece of information of the sticky note in person, or the like, and makes a meeting progress using a shared screen which is a display device of the electronic sticky note control device 100. In the exemplary embodiment, the facilitator is included among the participants.

In general, a sticky note to which writing is completed is attached to the mount. That is, writing onto the sticky note is performed first and attaching the sticky note to the mount is performed thereafter.

However, it may be intended that the writing of the sticky note is performed after the attachment position of the sticky note is secured depending on a meeting progress method and a participant's way of thinking. For example, it may be intended that in a case where a participant receives impetus from the content of a sticky note A and an idea arises, an assertion that a sticky note B, which is intended to be attached, is present in a position adjacent to the sticky note A is performed prior to writing which needs time. That is, the sticky note A and the sticky note B (however, a sticky note which is in a state of being unwritten) may be intended to be associated with each other. This is because, for example, a situation where the position of the sticky note A after the movement is required to be found out after the sticky note A is moved (actually, a situation where a sticky note is moved after another sticky note is attached frequently occurs) and writing on the sticky note B is made, occurs. In such a case, although the sticky note B itself is in a state of being unwritten, it is intended to secure an attachment position of the sticky note B.

In the sticky note system which allows only attaching of the sticky note onto which writing is completed to the mount (that is, a sticky note system in which only simultaneous performing of an operation of determining an attachment position of the sticky note and processing of actually attaching the sticky note is allowed), the facilitator needs the following requirements. It is regarded that there are a main facilitator and a sub-facilitator. The main facilitator arranges the sticky notes sent from the participants and the sub-facilitator prepares a group sticky note, which is a representative of several sticky notes, while understanding the contents of the sticky notes, and performs attaching of the sticky notes to appropriate positions.

The participants would attach the sticky note to the mount in synchronization with the flow of their conversation, but in such a sticky note system, it is needed to perform writing onto a sticky note, transmit the sticky note, and determine a position of the sticky note on a mount.

Therefore, the sticky notes need to be accumulated on a terminal (corresponds to the electronic sticky note terminal 150) in a state of being subjected to writing. On the other hand, if the position is not determined on the spot where writing onto the sticky note is performed, the sticky note preparer needs to remember somewhere the participant intends to attach the sticky note” and when there are plural sticky notes, confusion is caused. For that reason, there may be a request that the participant would perform the sticky note preparation and the attachment position determination on the spot. Here, the sticky note preparation is to prepare a new sticky note (blank sticky note) and may not include writing of contents onto the sticky note (completion of a sticky note).

The electronic sticky note control device 100 includes a data transmission and reception module 105, a shared screen display module 110, a sticky note operation processing module 115, a shared screen sticky note control module 120, a shared screen operation history recording module 125, a neighborhood sticky note determination module 130, and a sticky note movement determination module 135. The electronic sticky note control device 100 may individually perform an operation (reservation) for determining a sticky note attachment position and processing of actually attaching the sticky note. For that reason, a period spanning from a reservation to an actual attachment processing occurs and there is a possibility that a movement of the original sticky note or the like is performed within the period. That is, a situation of the sticky note on the mount at a point in time when the reservation is performed may differ from a situation of the sticky note at a point in time when the sticky note is actually attached.

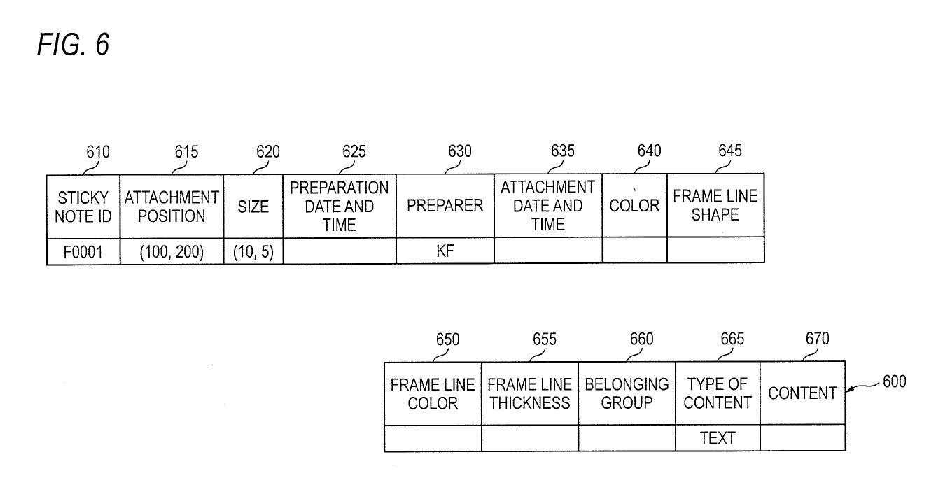

The data transmission and reception module 105 is connected with the shared screen sticky note control module 120, and also connected with the data transmission and reception module 155 of the electronic sticky note terminal 150 through the communication line 199. The data transmission and reception module 105 communicates with the electronic sticky note terminal 150. For example, the data transmission and reception module 105 receives a piece of information about the sticky note, the reservation of the attachment position of the sticky note, or the like from the electronic sticky note terminal 150. For example, a sticky note information table 600 is received as the piece of information about the sticky note. FIG. 6 is an explanatory diagram illustrating an example of a data structure of the sticky note information table 600. The sticky note information table 600 includes a sticky note ID field 610, an attachment position field 615, a size field 620, a preparation date and time field 625, a preparer field 630, an attachment date and time field 635, a color field 640, a frame line shape field 645, a frame line color field 650, a frame line thickness field 655, a belonging group field 660, a type of content field 665, and a content field 670. In the exemplary embodiment, a piece of information (sticky note identification (ID)) for uniquely identifying the sticky note is stored in the sticky note ID field 610. A position where the sticky note is attached is stored in the attachment position field 615. That is, a position on a mount is stored in the attachment position field 615. For example, the position is the coordinates in the XY-coordinate system of the mount. A size of the sticky note is stored in the size field 620. For example, in a case where the sticky note intended to be displayed has a rectangular shape, the width and height of the sticky note is stored in the size field 620. A date and time at which the sticky note is prepared (year, month, day, time, minute, second, smaller unit than a second, or a combination thereof) are stored in the preparation date and time field 625. A preparer (preparer ID) of the sticky note is stored in the preparer field 630. Otherwise, an information processing apparatus by which the sticky note is prepared (a device ID of the electronic sticky note terminal 150 or the electronic sticky note control device 100) may be stored in the preparer field 630. A date and time at which the sticky note is attached on the mount is stored in the attachment date and time field 635. A display color of the sticky note is stored in the color field 640. A frame line shape (a solid line, a dotted line, a broken line, a wavy line, double lines) in displaying the sticky note is stored in the frame line shape field 645. A frame line color in displaying the sticky note is stored in the frame line color field 650. A frame line thickness in displaying the sticky note is stored in the frame line thickness field 655. A piece of information relating to a group to which the sticky note belongs is stored in the belonging group field 660. For example, a piece of information, which indicates whether the sticky note belongs to a group or not, may be stored in the belonging group field 660.

In a case where the sticky note belongs to a group, a group ID, an ID of another sticky note which belongs to the group, or the like may be stored in the belonging group field 660. A type of the content of the sticky note (text information, vector data indicating handwritten characters, figures or the like, voice information, information of a still image such as a photograph, information of a video, or information indicating a combination thereof) is stored in the type of content field 665. The content written onto the sticky note is stored in the content field 670.

Here, the “reservation of the attachment position of the sticky note” received by the data transmission and reception module 105 is performed before the sticky note is attached to the mount and corresponds to a designation of an attachment position of the sticky note. That is, in the reservation, the sticky note is not actually attached, but an attachment position of the sticky note is designated when attaching of the sticky note is performed in the future. For example, the data transmission and reception module 105 may receive data including the sticky note ID field 610 and the attachment position field 615 of the sticky note information table 600 and may use a date and time at which the data is received as a “data and time when the attachment position of the sticky note is designated”. The data transmission and reception module 105 may receive data including the sticky note ID field 610, the attachment position field 615, and the preparation date and time field 625 of the sticky note information table 600 and may use the date and time contained in the preparation date and time field 625 as a “data and time when the attachment position of the sticky note is designated”.

The data transmission and reception module 105 may transmit a reduced image (thumbnail) of a shared screen (mount to which the sticky note is attached), which is displayed by the shared screen display module 110 for the electronic sticky note terminal 150, or the like, to the electronic sticky note terminal 150.

Receiving of a reservation of the attachment position of the sticky note by the data transmission and reception module 105 may be performed when the reservation is made in the electronic sticky note terminal 150 and otherwise, a complete sticky note may be received from the electronic sticky note terminal 150 and the reservation may be added to the complete sticky note. In the former case, a figure indicating that a sticky note will be attached to a reserved position in the future may be displayed on the mount. In this case, other participants may also recognize that a sticky note will be attached to the position in the future. Also, in the latter case, a reduction (including a case where there is no need to remember the attachment position) of a necessity for remembering the attachment position of the sticky note of an operator (participant) of the electronic sticky note terminal 150 is caused.

The shared screen display module 110 is connected with the shared screen sticky note control module 120. The shared screen display module 110 controls displaying on a display device such as a liquid crystal display (in particular, a large-scale liquid crystal display) which is connected with the electronic sticky note control device 100. In the shared screen display module 110, the operation performed by the facilitator or the like is reflected or the sticky note transmitted from the electronic sticky note terminal 150 is displayed.

The sticky note operation processing module 115 is connected with the shared screen sticky note control module 120. The sticky note operation processing module 115 receives an operation for the sticky note by the facilitator or the like and performs processing according to the operation. Here, the operation includes, for example, movement, expansion and reduction, alteration of an attribute (for example, color), grouping of the sticky note or the like.

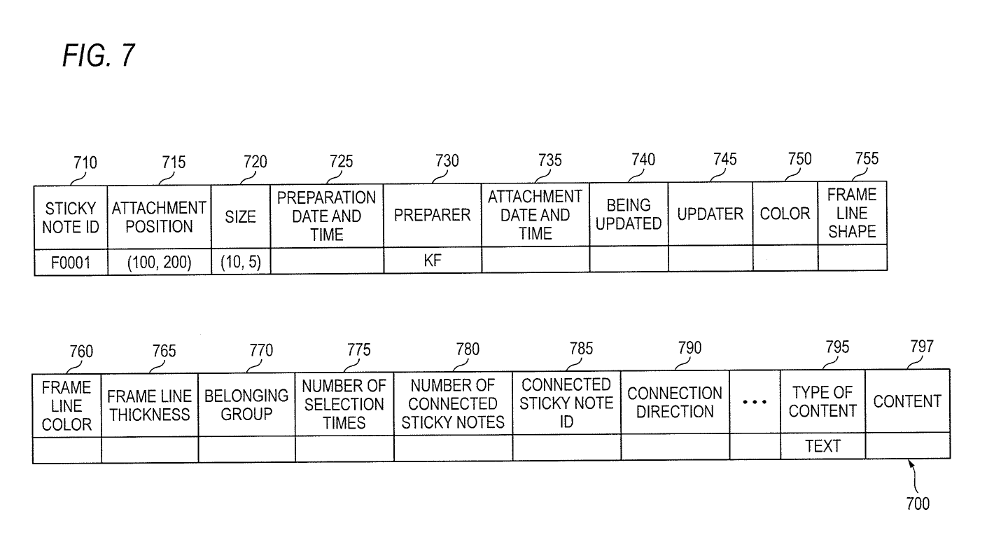

The shared screen sticky note control module 120 is connected with the data transmission and reception module 105, the shared screen display module 110, the sticky note operation processing module 115, the shared screen operation history recording module 125, the neighborhood sticky note determination module 130, and the sticky note movement determination module 135. The shared screen sticky note control module 120 performs control of the sticky note attached to the mount. For example, the shared screen sticky note control module 120 controls the sticky note using a sticky note information table 700. FIG. 7 is an explanatory diagram illustrating an example of the data structure of the sticky note information table 700. The sticky note information table 700 includes a sticky note ID field 710, an attachment position field 715, a size field 720, a preparation date and time field 725, a preparer field 730, an attachment date and time field 735, a being updated field 740, an updater field 745, a color field 750, a frame line shape field 755, a frame line color field 760, a frame line thickness field 765, a belonging group field 770, the number of selection times field 775, the number of connected sticky notes field 780, a connected sticky note ID field 785, a connection direction field 790, a type of content field 795, and a content field 797. The sticky note information table 700 is formed by adding the being updated field 740, the updater field 745, the number of selection times field 775, the number of connected sticky notes field 780, the connected sticky note ID field 785, and the connection direction field 790 to the sticky note information table 600. In the exemplary embodiment, a piece of information (sticky note identification (ID)) for uniquely identifying the sticky note is stored in the sticky note ID field 710. A position where the sticky note is attached is stored in the attachment position field 715. That is, a position on a mount is stored in the attachment position field 715. For example, the position is the coordinates in the XY-coordinate system of the mount. Specifically, the position is specified by movement processing performed by the sticky note operation processing module 115. A size of the sticky note is stored in the size field 720. For example, in a case where the sticky note intended to be displayed has a rectangular shape, the width and height of the sticky note is stored in the size field 720. A date and time at which the sticky note is prepared is stored in the preparation date and time field 725. A preparer (preparer ID) of the sticky note is stored in the preparer field 730. Otherwise, an information processing apparatus by which the sticky note is prepared (a device ID of electronic sticky note terminal 150 or electronic sticky note control device 100) may be stored in the preparer field 730. A date and time at which the sticky note is attached on the mount is stored in the attachment date and time field 735. A piece of information (flag) indicating whether the sticky note is being updated or not is stored in the being updated field 740. The updater (user ID) who performs the update is stored in the updater field 745. The updater may be either a single person or persons. A display color of the sticky note is stored in the color field 750. The display color includes, for example, a color indicating that the sticky note is being updated. A frame line shape (a solid line, a dotted line, a broken line, a wavy line, double lines) in displaying the sticky note is stored in the frame line shape field 755. The frame line shape includes, for example, a frame line shape indicating that the sticky note is being updated. A frame line color in displaying the sticky note is stored in the frame line color field 760. The frame line color includes, for example, a color indicating that the sticky note is being updated. A frame line thickness in displaying the sticky note is stored in the frame line thickness field 765. The frame line thickness includes, for example, a frame line thickness indicating that the sticky note is being updated. A piece of information related to a group to which the sticky note belongs is stored in the belonging group field 770. For example, a piece of information, which indicates whether a sticky note belongs to a group or not, may be stored in the belonging group field 770. In a case where the sticky note belongs to a group, a group ID, an ID of another sticky note which belongs to the group, or the like may be stored in the belonging group field 770. The number of selected times of the sticky note is stored in the number of selection times field 775. The number of selected times may include, for example, the number of selected times by a topic selecting operation. The number of sticky notes connected to the selected sticky note is stored in the number of connected sticky notes field 780. The next connected sticky note ID field 785 and the next connection direction field 790 may be repeated by the number of connected sticky notes. A sticky note ID of a sticky note connected to the selected sticky note is stored in the connected sticky note ID field 785. The connected sticky note ID is used for extracting, for example, a second sticky note related to a sticky note which is regarded as a target. A connection direction of the sticky note of the connection direction field 790 and the sticky note of the immediately preceding connected sticky note ID field 785 is stored in the connection direction field 790. The connection direction may be either a piece of information indicating that the sticky note (or the sticky note of the immediately preceding connected sticky note ID field 785) is located at an upstream (connection source)/downstream (connection destination) side or the sticky note ID of the sticky note located at an upstream (or downstream) side. In a case of non-directional connection, the connection direction field 790 may be empty (NULL) and may be made unnecessary. The connection direction indicates, for example, a positional relationship between the sticky note regarded as a target to be updated and a second target related to the target. In a case where the second target is moved, the second target is moved while maintaining the positional relationship. A type of the content of the sticky note (text information, vector data indicating handwritten characters, figures or the like, voice information, information of a still image such as a photograph, information of a video, or information indicating a combination thereof) is stored in the type of content field 795. The content written onto the sticky note is stored in the content field 797. In a state where the sticky note is not attached on the mount, the attachment position field 715 may be empty (NULL) and may contain a predetermined value (default value).

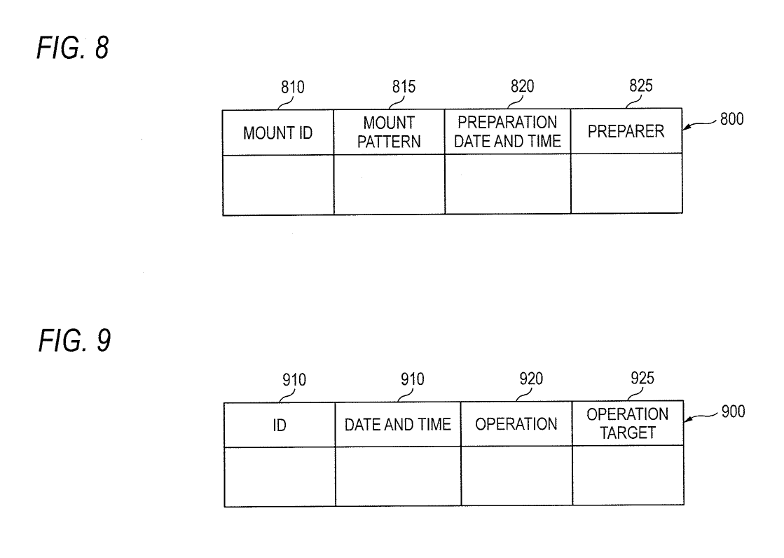

The shared screen sticky note control module 120 performs control of the mount. For example, the shared screen sticky note control module 120 controls the mount using a mount information table 800. FIG. 8 is an explanatory diagram illustrating an example of a data structure of the mount information table 800. The mount information table 800 includes a mount ID field 810, a mount pattern field 815, a preparation date and time field 820, and a preparer field 825. A piece of information (mount ID) for uniquely identifying the mount is stored in the mount ID field 810 in the exemplary embodiment. A mount pattern which becomes a background is stored in the mount pattern field 815. For example, the mount pattern includes a blank paper, a pattern of a table format, or the like. A preparation date and time of the mount is stored in the preparation date and time field 820. A preparer of the mount is stored in the preparer field 825.

The shared screen sticky note control module 120 receives a designation of an attachment position of the sticky note from the electronic sticky note terminal 150 through the data transmission and reception module 105 before the sticky note is attached to the mount.

When the sticky note is attached to the designated position, the shared screen sticky note control module 120 presents warning in a case where a result of comparison between a state of another sticky note in the vicinity of a designated position of a sticky note when a position of the sticky note is designated and a state of the other sticky note in the vicinity of an attachment position of the sticky note when the sticky note has been attached matches with a predetermined condition. That is, the shared screen sticky note control module 120 compares a state when the position reservation has been performed (past) and a state at the time when the sticky note is actually attached (present), and presents warning to draw an attention to attaching of the sticky note to the designated position in a case where there is a change. Presenting of warning includes, for example, displaying of a warning statement on a display device, outputting of a warning voice from a voice output device such as a speaker, vibrating or the like, a notification to the electronic sticky note terminal 150 or the like, or the combination thereof. Accordingly, the presenting of warning may be performed by the electronic sticky note control device 100, warning may be presented to the electronic sticky note terminal 150 when transmitting the sticky note, or both of which may be performed as a scheme that presents warning.

A candidate of an attachment position of the sticky note may be presented as the warning. The candidate of the attachment position is a position other than a reserved position and may be, for example, in the vicinity of a position of the moved sticky note.

A “predetermined condition (A)” may include a situation in which another sticky note, which has been present in the vicinity of a designated position when a position is designated, is moved far away more than a predetermined distance or moved greater than or equal to the predetermined distance when the sticky note is attached. Specifically, the “predetermined condition (A)” corresponds to a case where, although the sticky note is assumed to be attached to a position in the vicinity of a sticky note A when preparing of the sticky note is started (when the position reservation is performed), the sticky note A is moved before the sticky note is actually attached. In this regard, warning may not need to be presented for a fine movement (movement of which movement amount is less than or equal to or shorter than a predetermined distance).

A “predetermined condition (B)” may include a situation in which another sticky note, which has not been present in the vicinity of a designated position when a position is designated, is present in the position when a sticky note is attached. This corresponds to a reverse case to the case described above, specifically, corresponds to a case where although it is assumed that the designated position is empty or a sticky note is attached to a position separated from a sticky note B when preparing of the sticky note is started (when making the position reservation), the designated position is not empty or the sticky note B is present close to the sticky note before the target sticky note is actually attached.

A “predetermined condition (C)” may include a situation in which a sticky note, which overlaps another sticky note if the sticky note is attached to a designated position when a position is designated, does not overlap the sticky note when the sticky note is attached. Specifically, the “predetermined condition (C)” corresponds to a case where, although it is assumed that the sticky note overlaps the sticky note C when preparing of the sticky note is started (when the position reservation is performed), the sticky note C is moved when the sticky note is actually attached.

The “state of another sticky note in the vicinity of a designated position when a position is designated” is extracted from the shared screen operation history recording module 125. That is, the “state of another sticky note” may be determined from the history of operations performed in the past (when the designation of the attachment position for the sticky note has been performed) in the mount.

Regarding the neighboring sticky note (which is present in the neighborhood) A, a result of processing performed by the neighborhood sticky note determination module 130 is used. Here, the “neighborhood” refers to a distance between a sticky note, which is set to a target (a sticky note of which the position is designated) and another sticky note (a sticky note attached to the mount) and the distance being fallen within a predetermined distance. Here, the distance between the sticky notes may be a distance between a predetermined positions within the sticky notes (for example, a distance between the centers of both sticky notes, a distance between upper right corners of both of the sticky notes, or the like), or a distance of the shortest blank between the sticky notes. The distance between the sticky notes may include a distance in which both of the sticky notes are overlapping each other may be included.

The comparison of a past state (when the designation of the attachment position for the sticky note has been performed) with a present state (when the sticky note is actually attached) may be performed using the result of processing performed by the sticky note movement determination module 135.

The shared screen operation history recording module 125 is connected with the shared screen sticky note control module 120. The shared screen operation history recording module 125 stores a history of operations performed by the user (for example, a facilitator) in the electronic sticky note control device 100. For example, the shared screen operation history recording module 125 stores a history table 900. FIG. 9 is an explanatory diagram illustrating an example of a data structure of the history table 900. The history table 900 includes an ID field 910, a date and time field 915, an operation field 920, and an operation target field 925. An ID of the history is stored in the ID field 910. A date and time at which an operation is performed is stored in the date and time field 915. An operation is stored in the operation field 920. An operation target (specifically, the sticky note ID, or the like) is stored in the operation target field 925.

The neighborhood sticky note determination module 130 is connected with the shared screen sticky note control module 120. The neighborhood sticky note determination module 130 extracts a state of an area in the vicinity of a sticky note (a sticky note of which position is designated) which is set as a target. For example, a sticky note which is present in the area is extracted. A state of an area in the vicinity when the position reservation is performed, which corresponds to an action which has been performed in the past, and a state of an area in the vicinity when the sticky note is attached, which corresponds to an action which is performed in the present, are extracted by the control of the shared screen sticky note control module 120. Accordingly, a difference between the states is able to be extracted so as to extract the sticky note (including a sticky note which has not been present in the area in the past but is attached to the area in the present).

The sticky note movement determination module 135 is connected with the shared screen sticky note control module 120. The sticky note movement determination module 135 calculates a movement distance of the sticky note extracted by the neighborhood sticky note determination module 130. The calculated movement distance is used in a comparison with the “predetermined distance” described above and is used for determining, by the shared screen sticky note control module 120, whether warning is to be presented or not.

The electronic sticky note terminal 150 includes the data transmission and reception module 155, a shared screen display module 160, a sticky note operation processing module 165, a sticky note preparation module 170, a terminal sticky note control module 175, a terminal sticky note position designation recording module 180, and a shared screen attachment position decision processing module 185.

The data transmission and reception module 155 is connected with the terminal sticky note control module 175, and also connected with the data transmission and reception module 105 of the electronic sticky note control device 100 through the communication line 199. The data transmission and reception module 155 communicates with the electronic sticky note control device 100. For example, the data transmission and reception module transmits a piece of information about the sticky note (sticky note information table 600), a piece of information about the reservation of the attachment position of the sticky note or the like to the electronic sticky note terminal 150. Specifically, as described above, the piece of information about the sticky note includes the sticky note information table 600 and the reservation of the attachment position of the sticky note includes the sticky note ID field 610, the attachment position field 615, and the preparation date and time field 625 of the sticky note information table 600. The data transmission and reception module 155 receives a reduced image of the shared screen or the like from the electronic sticky note control device 100.

The shared screen display module 160 is connected with the terminal sticky note control module 175. The shared screen display module 160 displays the reduced image of the shared screen, which is received by the data transmission and reception module 105, on a display device such as a liquid crystal display or the like of the electronic sticky note terminal 150, or the like. The reduced image of the shared screen is used in the “designation of the attachment position of the sticky note”. That is, the “designation of the attachment position of the sticky note” is performed on the reduced image of the shared screen.

The sticky note operation processing module 165 is connected with the terminal sticky note control module 175. In the sticky note operation processing module 165, processing related to the sticky note is performed according to the operation of the user. For example, an instruction to move the sticky note, an instruction to alter an attribute of the sticky note, or the like is performed.

The sticky note preparation module 170 is connected with the terminal sticky note control module 175. The sticky note preparation module 170 performs sticky note preparation processing according to the operation of the user.

The terminal sticky note control module 175 is connected with the data transmission and reception module 155, the shared screen display module 160, the sticky note operation processing module 165, the sticky note preparation module 170, the terminal sticky note position designation recording module 180, and the shared screen attachment position decision processing module 185. The terminal sticky note control module 175 performs processing related to the sticky note according to the operation of the user and transmits a processing result (a designation or the like) to the electronic sticky note control device 100.

The terminal sticky note position designation recording module 180 is connected with the terminal sticky note control module 175. The terminal sticky note position designation recording module 180 is adapted to determine the attachment position of the sticky note (a position reservation) in advance according to the operation of the user in preparing the sticky note. The shared screen attachment position decision processing module 185, which is adapted to set an attachment position 615 in a case of using the sticky note ID field 610, the attachment position field 615, and the preparation date and time field 625 within the sticky note information table 600 as the reservation of the attachment position of the sticky note described above, is connected with the terminal sticky note control module 175.

The shared screen attachment position decision processing module 185 is connected with the terminal sticky note control module 175. The shared screen attachment position decision processing module 185 records a date and time at which the “reservation of the attachment position of the sticky note” is performed by the terminal sticky note position designation recording module 180. The preparation date and time field 625 is set as the reservation of the attachment position of the sticky note as described above in a case of using the sticky note ID field 610, the attachment position field 615, and the preparation date and time field 625 within the sticky note information table 600.

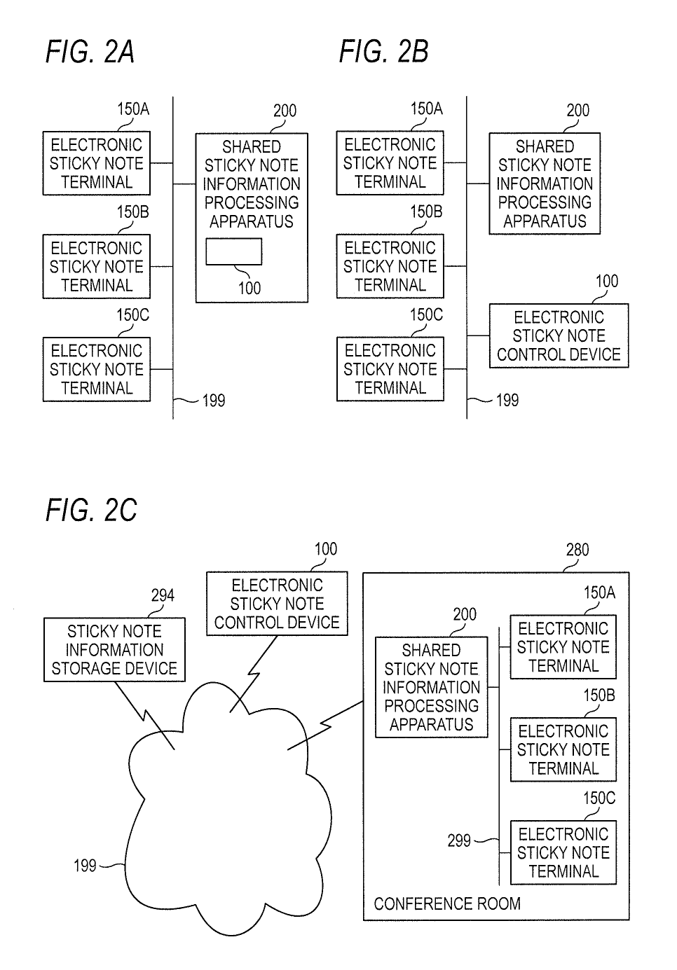

FIGS. 2A 2B, and 2C are explanatory diagrams illustrating a configuration example of a sticky note system using the exemplary embodiment. The shared sticky note information processing apparatus 200 is, in general, provided with a large screen display device and is operated by the facilitator. The display device is adapted to be able to seen by all participants. Each electronic sticky note terminal 150 is operated by each participant in the meeting and, in general, each participant owns a single electronic sticky note terminal. For example, a tablet-type terminal or the like is used as the electronic sticky note terminal 150.

In the example of FIG. 2A, the shared sticky note information processing apparatus 200 includes the electronic sticky note control device 100. The shared sticky note information processing apparatus 200, an electronic sticky note terminal 150A, an electronic sticky note terminal 150B, and an electronic sticky note terminal 150C are connected with each other through the communication line 199. The communication line 199 may be a wired communication network, a wireless communication network, or a combination of the wired communication network and the wireless communication network, and may be, for example, the Internet and the Ethernet as a communication infrastructure. In this case, the electronic sticky note control device 100 performs processing on the mount and the sticky note displayed on the screen of the shared sticky note information processing apparatus 200. The electronic sticky note control device 100 transmits displayed contents of the screen of the shared sticky note information processing apparatus 200 to each electronic sticky note terminal 150.

In the example of FIG. 2B, the electronic sticky note control device 100, the shared sticky note information processing apparatus 200, the electronic sticky note terminal 150A, the electronic sticky note terminal 150B, and the electronic sticky note terminal 150C are connected with each other through the communication line 199. In this case, the shared sticky note information processing apparatus 200 and each electronic sticky note terminal 150 use the electronic sticky note control device 100 through the communication line 199. The mount and the sticky note are displayed on the screens of the shared sticky note information processing apparatus 200 and each electronic sticky note terminal 150 according to the control performed by the electronic sticky note control device 100. The function performed by the electronic sticky note control device 100 may be implemented by a cloud service.

In the example of FIG. 2C, the shared sticky note information processing apparatus 200, the electronic sticky note terminal 150A, the electronic sticky note terminal 150B, and the electronic sticky note terminal 150C are installed in the conference room 280 and the meeting is performed. The shared sticky note information processing apparatus 200, the electronic sticky note terminal 150A, the electronic sticky note terminal 150B, and the electronic sticky note terminal 150C are connected with each other through a communication line 299. The electronic sticky note control device 100, the sticky note information storage device 294, and devices installed within the conference room 280 are connected with each other through the communication line 199. The functions by the electronic sticky note control device 100 and the sticky note information storage device 294 may be implemented by a cloud service.

The sticky note information storage device 294 stores a piece of information related to a sticky note and the electronic sticky note control device 100 performs the processing using the sticky note information storage device 294. In this case, the shared sticky note information processing apparatus 200 may transmit displayed contents of the screen of the shared sticky note information processing apparatus 200 to each electronic sticky note terminal 150 using the electronic sticky note control device 100 so as to cause the displayed contents of the screen to be displayed on the screen of the each electronic sticky note terminal 150. The shared sticky note information processing apparatus 200 and each electronic sticky note terminal 150 may be adapted to use the electronic sticky note control device 100.

FIG. 3A is an explanatory diagram illustrating an example of a conference room, FIG. 3B is an explanatory diagram illustrating an example of use of the shared sticky note information processing apparatus 200, and FIG. 3C is an explanatory diagram illustrating an example of use of the electronic sticky note terminal 150 using the exemplary embodiment.

As illustrated in FIG. 3A, the participants 311 and 312, and a facilitator 321 are gathered in a conference room or the like. The participant 311 uses the electronic sticky note terminal 150A and the participant 312 uses the electronic sticky note terminal 150B. In general, a single terminal device (electronic sticky note terminal 150A or the like) is given to a single participant. As illustrated in FIG. 3C, the terminal device is a tablet type terminal having a size (For example, A4 size, B5 size, 7-inch to 10-inch size, or the like) in the order of a notebook computer like the electronic sticky note terminal 150, and is operated using human fingers, an electronic pen, or the like. A piece of information of the sticky note in which text data, handwritten characters, figures or the like is described is prepared by the participant. The terminal device is not limited to a tablet type terminal and may be a PC (including a notebook PC or the like) equipped with a keyboard, a mouse, or the like.

A shared sticky note information processing apparatus 200x illustrated in FIG. 3A is a projector and displays a mount and a sticky note. A shared sticky note information processing apparatus 200y is an electronic blackboard and detects movements of fingers of a facilitator 321 or the electronic pen, and receives the operation such as attaching of the sticky note to the mount (front surface), movement of the sticky note, associating of sticky notes with each other (grouping), or the like. For example, the shared sticky note information processing apparatus 200y is provided with an electronic pen and receives the operation to the mount and the sticky note by detecting detachment of the pen from a predetermined placement of the pen (lifting up of the pen by the facilitator 321 in order to perform the operation) and a position of the tip end of the pen (a situation where the tip end position of the pen comes into contact with the shared sticky note information processing apparatus 200y). For example, a sensor may be provided in the placement of the pen (a sensor causing a switch to be turned on and off by gravity of the pen or the like) and may detect that which pen of plural pens (a black pen, red pen, blue pen, or the like) is used. The shared sticky note information processing apparatus 200y may be a touch sensor in its entirety and may detect a position, at which contacting is made, on the display screen and a contact pressure on the display screen.

The shared sticky note information processing apparatus 200 may be the electronic board as illustrated in the example of FIG. 3B. In general, an electronic board is provided with a display device having a large screen (of which size is at least larger than the display device of the electronic sticky note terminal 150). The display device is a touch panel and detects a position, at which contacting is made, on the display screen and a contact pressure on the display screen. For example, the electronic board may be provided with a screen having a size of 80-inch or the like.

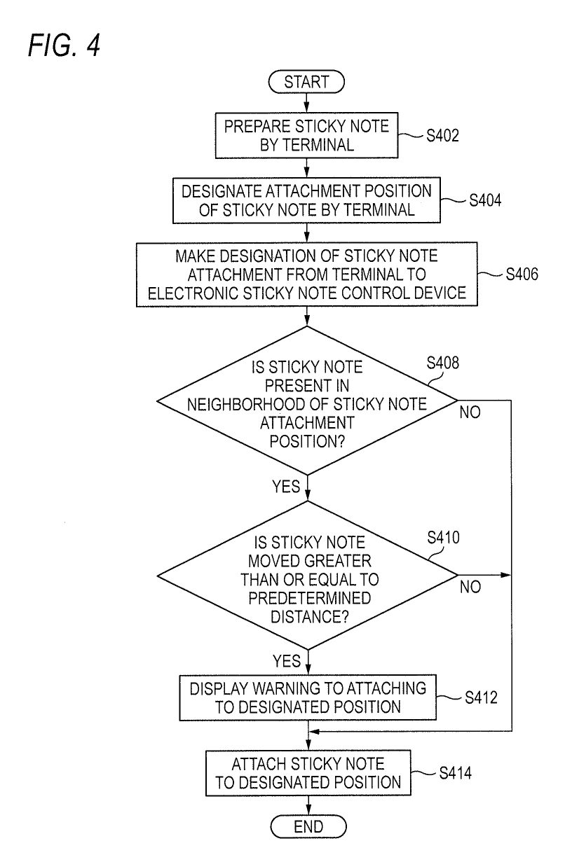

FIG. 4 is a flowchart illustrating an example of a process performed by the exemplary embodiment.

In Step S402, a sticky note is prepared by the electronic sticky note terminal 150 according to an operation of a participant.

In Step S404, an attachment position of the sticky note is designated by the electronic sticky note terminal 150 according to the operation of the participant.

In Step S406, a designation of the attachment position of the sticky note (transmission) is performed from the electronic sticky note terminal 150 to the electronic sticky note control device 100.

In Step S408, the shared screen sticky note control module 120 determines whether the sticky note is present in the vicinity of the attachment position of a target sticky note when the attachment position is designated (a reservation point in time of the attachment position) or not.

In a case where the sticky note is present in the neighborhood, the process proceeds to Step S410 and otherwise, the process proceeds to Step S414.

In Step S410, the shared screen sticky note control module 120 determines whether the sticky note (the sticky note which is present in the neighborhood) extracted in Step S408 is moved greater than or equal to a predetermined distance or not.

In a case where the sticky note is moved greater than or equal to a predetermined, the process proceeds to Step S412 and otherwise, the process proceeds to Step S414. That is, it is determined whether the movement distance between the reservation point in time of the attachment position and the sticky note (the sticky note which is present in the neighborhood) at the present time corresponds to a distance for which warning is to be presented or not.

In Step S412, the shared screen sticky note control module 120 displays warning to attaching of the sticky note to the designated position.

In Step S414, the shared screen sticky note control module 120 attaches the sticky note to the designated position.

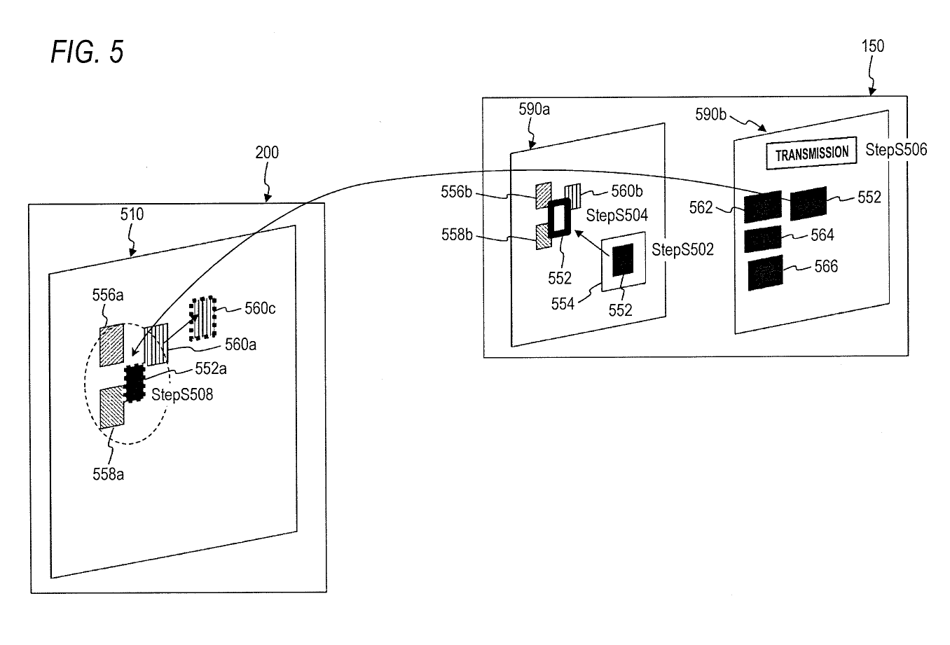

FIG. 5 is an explanatory diagram illustrating an example of processing performed by the exemplary embodiment. The shared sticky note information processing apparatus 200 displays a screen 510. Although a situation in which a screen 590a and a screen 590b are present in the electronic sticky note terminal 150 are represented, the matters represents that the screen 590b is displayed after the screen 590a is displayed on a screen of the electronic sticky note terminal 150. Both the screen 590a and the screen 590b may be displayed on the screen of the electronic sticky note terminal 150. In the screen 590a, a reduced screen of the screen 510 of the shared sticky note information processing apparatus 200 is displayed and a state where a sticky note 556b, a sticky note 558b, and a sticky note 560b are attached on a mount at first.

In Step S502, the electronic sticky note terminal 150 prepares a sticky note through the operation by the participant. Here, the preparation is to prepare a new sticky note and may not include preparing of contents of the new sticky note. That is, the sticky note does not need to be completed. In the example of FIG. 5, a sticky note 552 is prepared within a sticky note preparation area 554. A date and time at the point in time of the preparation of the sticky note is recorded by the terminal sticky note position designation recording module 180.

In Step S504, the attachment position of the sticky note is designated. At this point in time, the sticky note is not yet attached on the screen 510 of the shared sticky note information processing apparatus 200. In the example of FIG. 5, the sticky note 552 is attached within the screen 590a. In this example, the attached sticky note 552 is placed in the position which is surrounded by a sticky note 556b, a sticky note 558b, and a sticky note 560b. Thereafter, the content of the sticky note 552 is prepared and the sticky note 552 is completed.

In Step S506, the sticky note among a list of the saved sticky notes within the screen 590b is transmitted according to the operation of the participant. The screen 590b displays a list of sticky note capable of being transmitted to the shared sticky note information processing apparatus 200 among the sticky notes prepared by the electronic sticky note terminal 150.

In Step S508, the following matters are determined when the sticky note is attached and a change according to the determination result is informed to a user. (1) It is determined whether a change of the sticky note which is present in the vicinity (inside of an ellipsis rendered in a dotted line in FIG. 5) of the attachment position designated in Step S504 is present or not. (2) It is determined whether an amount of the change is greater than or equal to a predetermined value or not.

For example, although three sticky notes of the sticky note 556a, the sticky note 558a, the sticky note 560a are present in the vicinity of the attachment position designated in Step S504 at the point in time of Step S504, only the sticky note 556a and the sticky note 558a are present and the sticky note 560a is moved to the position of the sticky note 560c at the present time.

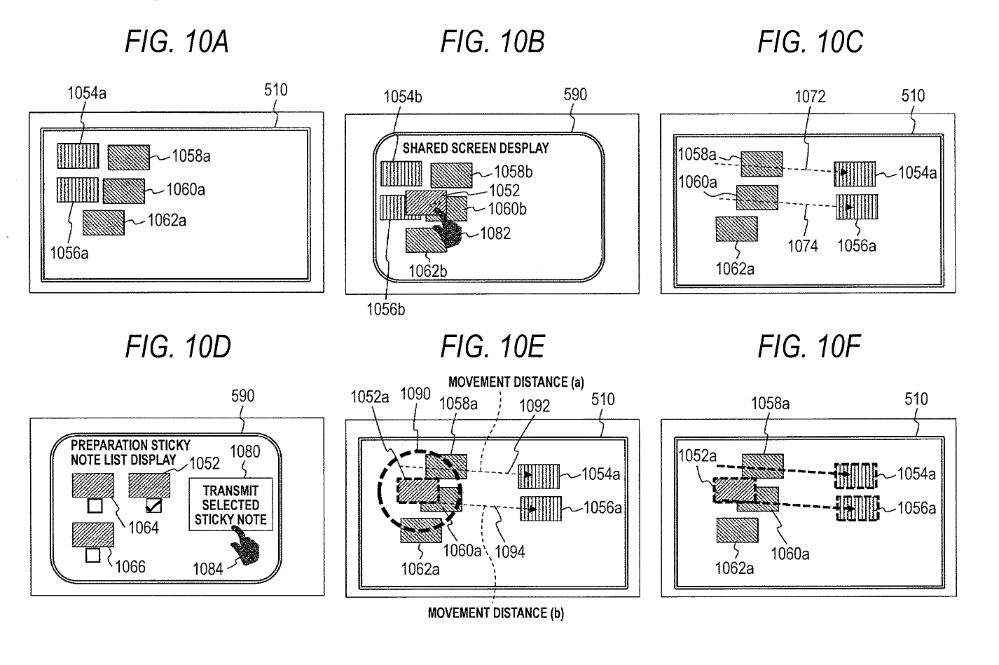

FIG. 10 is an explanatory diagram illustrating another example of processing performed by the exemplary embodiment. The screen 510 is a screen of the shared sticky note information processing apparatus 200 and a screen 590 is a screen of the electronic sticky note terminal 150.

The example of FIG. 10A indicates that five sticky notes (sticky note 1054a, sticky note 1056a, sticky note 1058a, sticky note 1060a, and sticky note 1062a) are displayed in the screen 510.

The example of FIG. 10B indicates that a sticky note 1052 (for example, a “group name” sticky note) which is a representative of five comments is prepared by the electronic sticky note terminal 150 and the attachment position is designated using a finger for operation 1082, according to the operation by the participant. The example of FIG. 10B indicates an example in which an attachment position of the sticky note 1052 is designated before the sticky note 1052 is attached in the screen 510 of the shared sticky note information processing apparatus 200. In the example of FIG. 10B, the screen 590 displays a reduced screen of the screen 510 and designating of the attachment position is performed on the reduced screen. That is, in the screen 590, five sticky notes (sticky note 1054b, sticky note 1056b, sticky note 1058b, sticky note 1060b, and sticky note 1062b) are displayed corresponding to the screen 510.

The example of FIG. 10C indicates that after the designating of the attachment position, the movement (movement 1072 and movement 1074) of the sticky notes (sticky note 1054a and sticky note 1056a illustrated in FIG. 10A), which is already attached, occurs (sticky note 1054a and sticky note 1056a illustrated in FIG. 10C) on the screen 510 of the shared sticky note information processing apparatus 200.

The example of FIG. 10D indicates an operation of transmitting the sticky note 1052 (the “group name” sticky note) to the shared sticky note information processing apparatus 200. Specifically, in the screen 590, the sticky note 1064, the sticky note 1066, and the sticky note 1052 which are capable of being transmitted are displayed, a check box is in the lower part of the screen.

The sticky note 1052 is selected and a “transmit selected sticky note” button 1080 is depressed by the finger for operation 1084.

The example of FIG. 10E indicates that when a new sticky note 1052a is attached, a quantity of a state change of the attachment position within a previously determined range is determined. Specifically, the sticky note 1052a is attached to the position indicated in the example of FIG. 10B. In a determination range 1090 which is in the vicinity of the sticky note 1052a, the sticky notes (sticky note 1054a and sticky note 1056a) moved from a reservation point in time (a point in time in the example of FIG. 10B) are extracted and the movement distances (movement distance (a) 1092 and movement distance (b) 1094) are calculated.

In the example of FIG. 10F, when it is determined that the movement (change), of which a movement distance is greater than or equal to a predetermined threshold value, is performed, the change is informed to the user. For example, the periphery of the sticky note 1052a is displayed with flickering, the sticky note 1054a and the sticky note 1056a are also displayed with flickering, and also the movement loci are displayed. The displaying is simply illustrative and may include displaying of a warning statement (the effect that a change is made after the reservation point in time), a change of color, outputting of a warning sound, or the like.

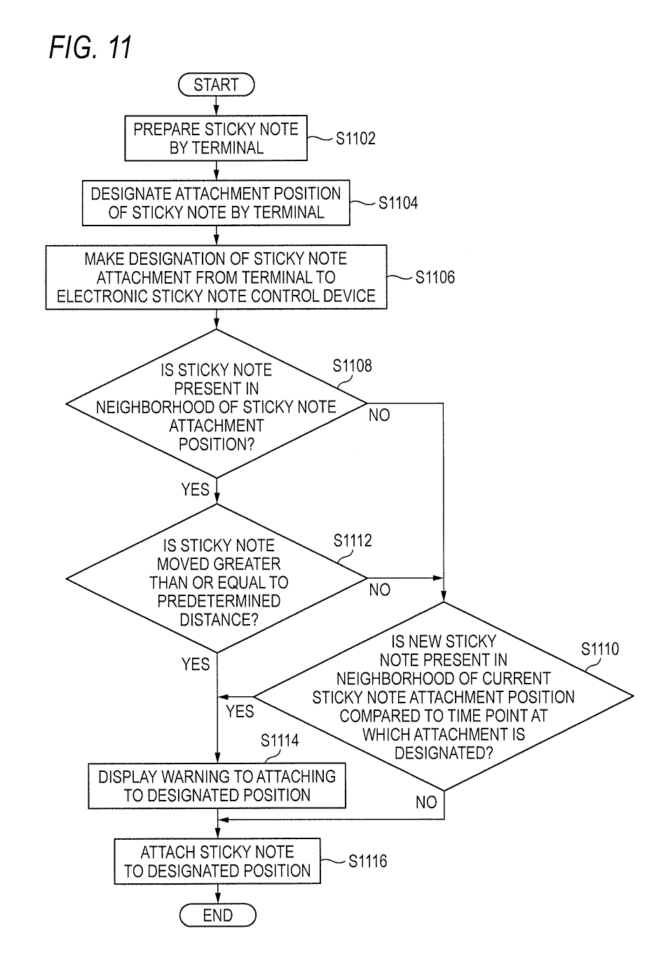

FIG. 11 is a flowchart illustrating another example of a process performed by the exemplary embodiment. The flowchart of FIG. 11 is formed by adding Step S1110 to the flowchart illustrated in FIG. 5.

In Step S1102, a sticky note is prepared by the electronic sticky note terminal 150 according to an operation of a participant.

In Step S1104, an attachment position of the sticky note is designated by the electronic sticky note terminal 150 according to the operation by the participant.

In Step S1106, a designation of the attachment position of the sticky note (transmission) is performed from the electronic sticky note terminal 150 to the electronic sticky note control device 100.

In Step S1108, the shared screen sticky note control module 120 determines whether the sticky note is present in the vicinity of the attachment position of the sticky note when the attachment position (a reservation point in time of the attachment position) is designated or not.

In a case where the sticky note is present in the neighborhood, the process proceeds to Step S1112 and otherwise, the process proceeds to Step S1110.

In Step S1110, it is determined whether the new sticky note is present in the neighborhood of the attachment position of the sticky note in the present time as compared to the point in time at which the attachment of the sticky note is designated.

In a case where the new sticky note is present, the process proceeds to Step S1114 and otherwise, the proceeds to Step S1116. That is, a warning is presented in a case where a sticky note is newly attached in the vicinity of the attachment position of the sticky note.

In Step S1112, the shared screen sticky note control module 120 determines whether a sticky note (the sticky note which is present in the neighborhood) extracted in Step S1108 is moved greater than or equal to a predetermined distance or not.

In a case where the sticky note is present in the neighborhood, the process proceeds to Step S1114 and otherwise, the process proceeds to Step S1110.

In Step S1114, the shared screen sticky note control module 120 displays warning to attaching of the sticky note to the designated position.

In Step S1116, the shared screen sticky note control module 120 attaches the sticky note to the designated position.

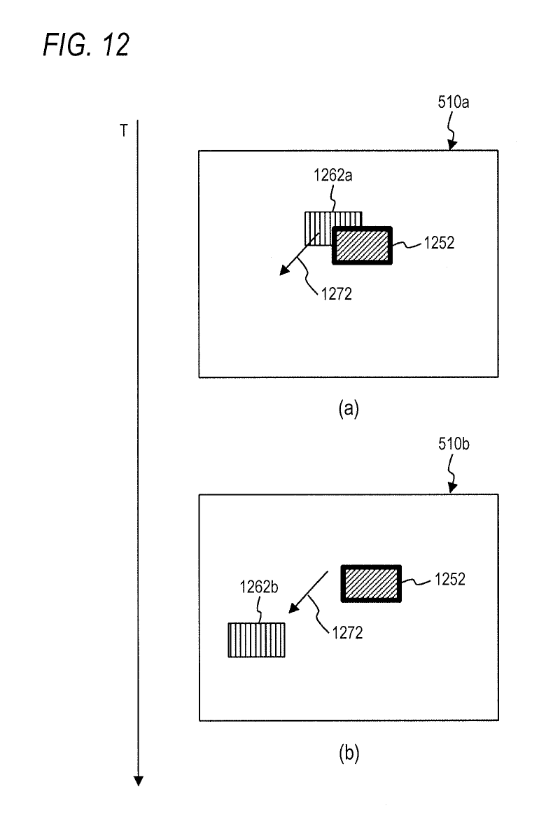

The example shown in (a) of FIG. 12 indicates that a sticky note 1262a is attached on a screen 510a and an attachment reservation of a sticky note 1252 is performed at that point in time. Thereafter, the sticky note 1262a is moved (1272) and then moved to a position of a sticky note 1262b as illustrated in (b) of FIG. 12. That is, the example shown in (a) of FIG. 12 indicates a case where although a position, at which a target sticky note overlaps another sticky, is designated at the attachment reservation point in time, the sticky note which having being overlapped with the target sticky note (a sticky note that although attaching is not performed at the attachment reservation point in time actually and thus overlapping itself does not occur, the sticky note is being overlapped with the target sticky note when attaching is performed at the attachment reservation point in time) is moved. This case corresponds to a case where warning is presented.

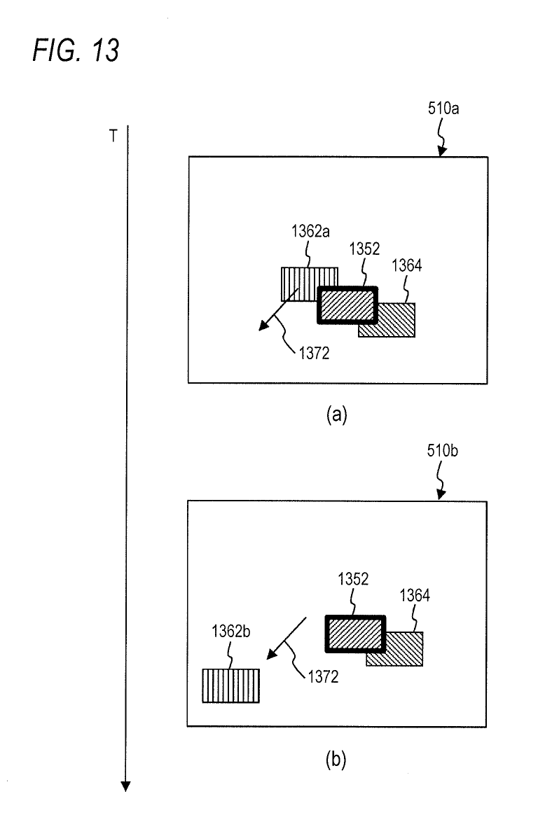

The example shown in (a) of FIG. 13 indicates that a sticky note 1362a and a sticky note 1364 are attached on the screen 510a and an attachment reservation of the sticky note 1352 is performed at that point in time. Thereafter, the sticky note 1362a is moved (1372) and then moved to a position of a sticky note 1362b as illustrated in (b) in FIG. 13. That is, the example shown in (a) of FIG. 13 indicates a case where although a position, at which a target sticky note overlaps plural other sticky notes, is designated at the attachment reservation point in time, the sticky note which having being overlapped with the target sticky note is moved. This case corresponds to a case where warning is presented.

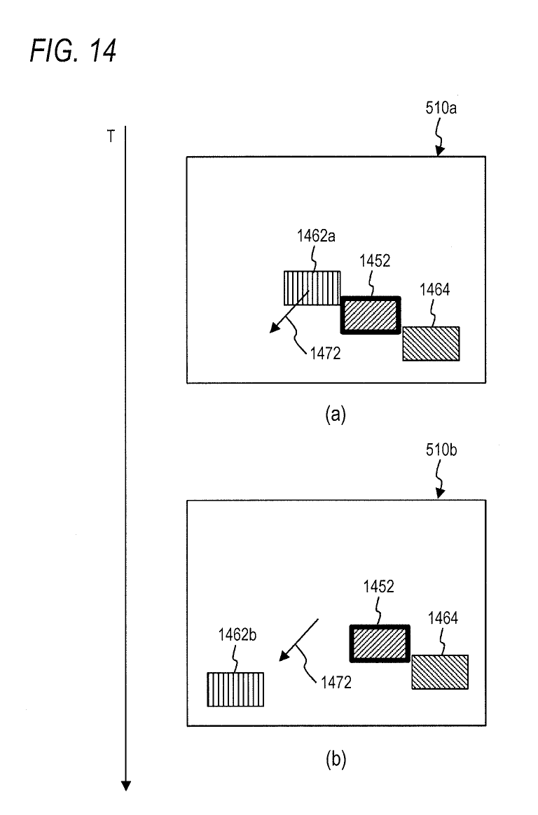

The example shown in (a) of FIG. 14 indicates that a sticky note 1462a and a sticky note 1464 are attached on the screen 510a and an attachment reservation of the sticky note 1452 is performed at that point in time. Thereafter, the sticky note 1462a is moved (1472) and then moved to a position of a sticky note 1462b as illustrated in (b) of FIG. 14. That is, the example shown in (a) of FIG. 14 indicates a case where although a position at which a target sticky note does not overlap another sticky is designated at the attachment reservation point in time, the sticky note which is present in a neighborhood is moved. This case corresponds to a case where warning is presented when a distance of movement (1472) is greater than or equal to a predetermined distance.

However, in a state illustrated in the examples of FIG. 12 to FIG. 14, whether it is preferable to present warning or whether it is not preferable to present warning depends on the following matters.
A) Whether a user intends to cause a position of a newly prepared sticky note to be close to the sticky notes (sticky note 1262a, sticky note 1362a, and sticky note 1462a) of which insides are filled with vertical lines.
B) Whether positional relationships between the newly prepared sticky note and the sticky notes (sticky note 1262a, sticky note 1362a, and sticky note 1462a), of which insides are filled with vertical lines, are remarkably changed (change of distance).

In the examples illustrated in FIG. 12 to FIG. 14, even when the positional relationships in the above B) are the same degree of change, it is natural to think that the intention of the above A) is different. For that reason, it is more preferable to perform a determination as to whether warning is to be presented or not using states of all (or some of) sticky notes which are present in neighborhood thereof and within a distance to be determined.

A “predetermined condition (A′)” may include a situation in which in a case where plural other sticky notes are present in the vicinity of a position when the position of a target sticky note is designated, the sticky notes more than or greater than or equal to a predetermined ratio (for example, 50%) is moved far away more than a predetermined distance or moved greater than or equal to the predetermined distance when the target sticky note is attached.

A “predetermined condition (B′)” may include a situation in which a ratio of the sticky notes, which were not present when the positions are designated, to the number of other sticky notes, which are present in the vicinity of the reserved position when the target sticky note is attached, is more than or greater than or equal to a predetermined ratio (for example, 50%).

A “predetermined condition (C′)” may include a situation in which if a target sticky note is attached to the reserved designated position when the position of the target sticky note is designated, a ratio of the sticky notes that does not overlap to the number of the sticky notes which overlap the target sticky notes is more than or greater than or equal to a predetermined ratio (for example, 50%).

With this, when a ratio of the sticky note satisfying the conditions (A, B, C) for presenting warning described above is more than or is greater than or equal to a predetermined ratio, warning is not presented.

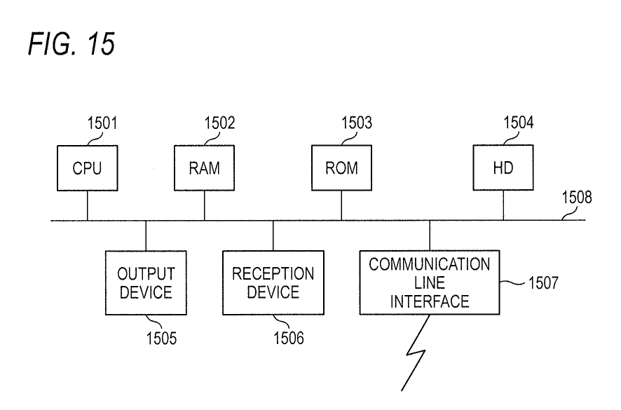

A hardware configuration of a computer (electronic sticky note control device 100 and electronic sticky note terminal 150), which executes a program, as the present exemplary embodiment is a general computer, specifically, a personal computer or a computer capable of becoming a server, as illustrated in FIG. 15. That is, as a specific example, a CPU 1501 is used as a processing unit (operation unit), a RAM 1502, a ROM 1503, and an HD 1504 are used as a storage device. For example, a hard disk or a solid state drive (SSD) may be used as the HD 1504. The computer includes the CPU 1501 that executes programs such as the data transmission and reception module 105, the shared screen display module 110, the sticky note operation processing module 115, the shared screen sticky note control module 120, the shared screen operation history recording module 125, the neighborhood sticky note determination module 130, the sticky note movement determination module 135, the data transmission and reception module 155, the shared screen display module 160, the sticky note operation processing module 165, the sticky note preparation module 170, the terminal sticky note control module 175, the terminal sticky note position designation recording module 180, the shared screen attachment position decision processing module 185, and the like, the RAM 1502 in which the program or data is stored, the ROM 1503 in which a program used for starting the computer of the present exemplary embodiment is stored, the HD 1504 which is an auxiliary storage device (which may be a flash memory or the like) which stores the sticky note information table 600, the sticky note information table 700, the mount information table 800, the history table 900, and the like, a reception device 1506 that receives data based on the operation of a keyboard, a mouse, a touch screen, a microphone or the like by a user, an output device 1505 such as a CRT, a liquid crystal device, a speaker or the like, a communication line interface 1507 for connecting with a communication network interface card or the like, and a bus 1508 for connecting the components described above and used for exchanging data between the components. Plural computers each of which includes the components may be connected with each other through a network.

Regarding matters corresponding to the computer program of the exemplary embodiments described above, a computer program which is software is read into a system having a hardware configuration of the present exemplary embodiment, and software resources and hardware resources are cooperated with each other to implement the exemplary embodiment described above.

The hardware configuration of the information processing apparatus illustrated in FIG. 15 illustrates just one configuration example, the present exemplary embodiment is not limited to the configuration illustrated in FIG. 15, and may be a configuration in which the modules described in the present exemplary embodiment are adapted to be executable. For example, some of the modules may include exclusive hardware (for example, an application specific integrated circuit (ASIC) or the like), some of the modules may be adapted to be connected by the communication line placed within an external system. Furthermore, plural systems each of which is illustrated in FIG. 15 may be connected to each other by the communication line to be cooperated with each other. In particular, the system may be incorporated into a portable information communication device (including a mobile phone, a smart phone, a mobile device, a wearable computer or the like), home information appliances, a robot, a copy machine, a facsimile, a scanner, a printer, a multifunction machine (image processing apparatus equipped with functions of two or more of a scanner, a printer, a copy machine, a facsimile or the like), in addition to the personal computer.

In the compare processing of the description of the exemplary embodiment described above, the expressions “or more”, “or less”, “greater than”, and “less than (smaller than)” may be respectively used as the expressions of “greater than”, “less than (smaller than)”, “or more”, and “or less”, as long as inconsistency in a combination of the expressions does not occur.

The program described above may be provided in a state of being stored in a recording medium or be provided by a communication unit. In this case, for example, the program described above may be considered as an invention of a “computer readable recording medium having a program recorded therein”.

The “non-transitory computer readable recording medium having a program recorded therein” refers to a recording medium used for installation, execution, distribution or the like of the program, having recorded a program therein, and is readable by a computer.

The recording medium may include, for example, a digital versatile disk (DVD) such as “DVD-R, DVD-RW, DVD-RAM, or the like” that are standards formulated by the DVD forum, “DVD+R, DVD+RW, or the like” that are standards formulated by the DVD+RW, a compact disk (CD) such as a CD-read only memory (CD-ROM), a CD-recordable (CD-R), a CD-rewritable (CD-RW) or the like, a Blu-ray (registered trademark) Disc, a magnetooptical disc (MO), a flexible disk (FD), a magnetic tape, a hard disk, a read-only memory (ROM), an electrically erasable programmable read-only memory (EEPROM (registered trademark)), a flash memory, a random access memory (RAM), a secure digital (SD) memory card, or the like.

A portion or the entirety of the program may be recorded in the recording medium to be saved or distributed. The portion or the entirety of the program may be transmitted, by communication, using a transmission medium such as a wired communication network, a wireless communication network, and a combination of the wired communication network and the wireless communication network, that are used, for example, in a local area network (LAN), a metropolitan area network (MAN), a wide area network (WAN), the Internet, the Ethernet, and an extra network, or may be carried by being superposed on a carrier wave.

Furthermore, the program may be a portion or the entirety of another program or may be recorded in the recording medium together with a separate program. The program may be divided to be recorded in plural recording media. The program may be recorded in any format such as a compressed format, an encrypted format, or the like as long as the program is restorable.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a reception unit that receives a designation of an attachment position of a sticky note before attachment of the sticky note to a mount; and
a warning unit that, when the sticky note is attached to the attachment position that is designated, presents a warning in a case where a comparison result between a state of other sticky note in a neighborhood of the attachment position at a time of the designation of the attachment position and a state of other sticky note in the neighborhood of the attachment position at a time of the attachment of the sticky note meets a predetermined condition.

2. The information processing apparatus according to claim 1,
wherein the predetermined condition is met in a case where the other sticky note which is present in the neighborhood of the attachment position at the time of the designation is moved a predetermined distance or greater than the predetermined distance at the time of the attachment of the sticky note from a position of the other sticky note at the time of the designation.

3. The information processing apparatus according to claim 1,
wherein the predetermined condition is met in a case where the other sticky note which is not present in the neighborhood of the attachment position at the time of the designation is positioned in the neighborhood of the attachment position at the time of the attachment of the sticky note.

4. The information processing apparatus according to claim 1,
wherein the predetermined condition is met in a case where the other sticky note which overlaps the attachment position of the sticky note at the time of the designation does not overlap the sticky note that is attached to the attachment position at the time of the attachment of the sticky note.

5. An information processing method comprising:
receiving a designation of an attachment position of a sticky note before attachment of the sticky note to a mount; and
warning, when the sticky note is attached to the attachment position that is designated, in a case where a comparison result between a state of other sticky note in a neighborhood of the attachment position at a time of the designation of the attachment position and a state of other sticky note in the neighborhood of the attachment position at a time of the attachment of the sticky note meets a predetermined condition.

6. A non-transitory computer readable medium storing a program causing a computer to function as:
a reception unit that receives a designation of an attachment position of a sticky note before attachment of the sticky note to a mount; and
a warning unit that, when the sticky note is attached to the attachment position that is designated, presents a warning in a case where a comparison result between a state of other sticky note in a neighborhood of the attachment position at a time of the designation of the attachment position and a state of other sticky note in the neighborhood of the attachment position at a time of the attachment of the sticky note meets a predetermined condition.
